(19) United States
(12) Patent Application Publication
(10) Pub. No.: US 2025/0136881 A1
(43) Pub. Date: May 1, 2025

(54) RENEWABLE JET-FUEL COMPOSITION

(71) Applicant: TotalEnergies OneTech, COURBEVOIE (FR)

(72) Inventors: Florent PICARD, Solaize (FR); France CHAVAIN, HARFLEUR (FR); Christophe GUERET, Solaize (FR)

(73) Assignee: TotalEnergies OneTech, COURBEVOIE (FR)

(21) Appl. No.: 18/691,358

(22) PCT Filed: Sep. 12, 2022
(86) PCT No.: PCT/EP2022/075311

§ 371 Date: Mar. 12, 2024

(30) Foreign Application Priority Data
Sep. 13, 2021 (EP) 21306253.2

(51) Int. Cl. C10L 1/04

(52) U.S. Cl. CPC C10L 1/04; C10L 2200/0484; C10L 2200/0492; C10L 2290/24

(57) ABSTRACT

A jet-fuel composition coming from renewable feedstocks comprising from 65% to 95% by mass at least one paraffinic base coming from a hydrotreatment of esters and fatty acids or a Fisher-Tropsch method and comprising 90% by mass paraffins and 5% to 35% by mass at least one C6-C16 or C8-C16 aromatic base, characterised in that said aromatic base corresponds to the C6-C16 or C8-C16 fraction of a biofuel produced by a method for converting into fuel at least one C2 bioalcohol and characterised in that said aromatic base contains at least 60% by mass aromatic compounds, said aromatic compounds comprising at least 50% by mass benzene substituted by at least C2-C5 n-alkyl, n being an integer from 1 to 3, and wherein the final jet-fuel composition comprises less than 9.5% by mass C6-C16 cycloalkanes.

### TECHNICAL FIELD

The present invention relates to the field of jet fuels and in particular a jet fuel resulting from renewable feedstocks.

### CONTEXT OF THE INVENTION

The conventional fuel of the jet fuel type is produced from crude oil and contains a complex mixture of hydrocarbons that typically have 6 to 18 carbon atoms. These hydrocarbons comprise linear and branched alkanes, cycloalkanes and aromatic hydrocarbons. Because of the feedstock of petroleum origin and the production methods, the conventional fuel of the jet-fuel type, also referred to as jet, typically contains up to 25% by mass aromatic hydrocarbons, more generally 10% to 25% by mass aromatic hydrocarbons. A significant proportion, normally of the order of at least 5% aromatic hydrocarbons, are polycyclic (i.e. they contain two or more aromatic rings) and generally of the naphthalene type. Such compounds are harmful to health (for example carcinogenic) and have poor combustion properties.

Environmental, economic and energy constraints have encouraged diversification of energy resources and development of novel fuels, in particular in the aviation field.

Renewable fuels derived from biological matter are an alternative to conventional fossil fuels. Conventional jet fuels can be mixed with paraffin bases coming from renewable feedstocks as provided for by the standard D7566-21, thus allowing the production of alternative aviation fuels. The bases for aviation fuel coming from renewable feedstocks that can be incorporated in fossil jet fuel are:
Synthetic paraffinic kerosenes [SPK], resulting from methods such as the Fischer-Tropsch method, the hydrotreatment of esters and fatty acids [HEFA-SPK] or produced by the alcohol-to-jet method (transformation of alcohol into kerosene) [ATJ-SBK].
Synthetic isoparaffins produced by hydrotreatment from fermented sugars [SIP-HFS].
Synthetic aromatic kerosenes obtained by alkylation of light aromatics of non-petroleum source [SPK/A].
Synthesis kerosenes obtained from the hydrothermal conversion of fatty acid esters and of fatty acid.
Synthetic paraffinic kerosenes [SPK] obtained from ester hydrocarbons and hydrotreated fatty acids.

Currently, these renewable aviation fuel bases cannot for the most part be used alone because of their composition very different from fossil jet fuels, which in particular pose problems of compatibility with the materials of the elements with which the fuel is in contact. On this point, the absence of aromatic compounds in the majority of the renewable aviation fuel bases available can cause problems of compatibility with the materials, and in particular certain seals.

In fact, a minimum aromatic compound content in the jet fuels is fixed at 8% by volume by the specification ASTM-D1655-21. Moreover, the aromatic compound content is limited to a maximum of 25% by volume in jet fuels according to the specification ASTMD1655-21a of jet fuel A1. An excessively high aromatic content and the incorporation of aromatics of the polyaromatic type may cause faulty combustion properties.

### PRIOR ART

The patent U.S. Pat. No. 10,731,085 describes a production of renewable fuel for diesel or jet applications containing paraffins and aromatics. The composition is obtained by hydroprocessing of biological feedstocks followed by fractionation. The composition contains 10 to 40% by mass C8-C30 cycloalkanes. The composition can be used in a mixture with a jet fuel coming from fossil feedstock.

The patent US 2009/0253947 describes a method, in particular an integrated production method, producing a fuel mixture from a paraffin-rich component and a component rich in cyclic compounds, each of the components being generated from a renewable raw material.

The patent EP3292187 describes an aromatic compound used in a mixture comprising a kerosene of petroleum origin and a biokerosene.

The patent FR3041360 describes a mixture of a kerosene that may be a synthetic paraffinic kerosene (SPK-HEFA or SPK-FT) or a synthetic isoparaffin (SIP) and one or more aromatic compounds that may be alone or in a mixture. The aromatic compounds described are substituted benzene and/or tetraline (C10H12) and/or decaline (C10H16). The proportion of benzene substituted by n methyls, n being an integer between 1 and 6, being between 2 and 15% by volume with respect to the total volume of the composition.

The document US 2009/0000185 describes a kerosene comprising a first component of nonpetroleum origin comprising mainly isoparaffins and n-paraffins and a second component comprising mainly hydrocarbons selected from cycloalkanes and aromatics.

None of these compositions makes it possible to optimise the proportion and type of aromatic compounds in the final jet-fuel composition in order to improve the quality of combustion, and in particular the smoke point, while ensuring good compatibility with the existing systems.

There is therefore a real need for a novel fuel coming exclusively from renewable feedstocks, in particular a jet fuel wherein the proportion of aromatics and mainly of monoaromatics is optimised by virtue of incorporating an aromatic base in a mixture with a mainly paraffinic base.

### DESCRIPTION OF THE INVENTION

The invention aims to provide a composition wherein the proportion of aromatics and the nature of said aromatics are optimised. In fact, an optimised proportion of aromatics makes it possible to adjust the blending, in particular to achieve the aromatics specification without introducing excess aromatics as is the case with fossil fuels. Furthermore, optimisation makes it possible to control the nature of the aromatics and to incorporate mainly monoaromatics making it possible to improve the combustion properties.

For this purpose, the invention relates to a jet-fuel composition coming from renewable feedstocks comprising:
a) from 65% to 95% by mass, preferably from 70% to 95% by mass, of at least one paraffinic base coming from a hydrotreatment of esters and fatty acids or from a Fischer-Tropsch method and comprising at least 90% by mass of paraffins,
b) from 5% to 35% by mass, preferably from 5% to 30% by mass, of at least one C6-C16 or C8-C16 aromatic base, characterised in that said aromatic base corresponds to the C6-C16 or C8-C16 fraction of a biofuel produced by a method for converting into fuel at least one C2 bioalcohol and characterised in that said aromatic base contains at least 60% by mass of aromatic compounds, said aromatic compounds comprising at least 50% by mass of benzene substituted by at least n C2-C5 alkyl, n being an integer from 1 to 3,
wherein said jet-fuel composition comprises less than 9.5% by mass of C6-C16 cycloalkanes.

Advantageously, the aromatic base can correspond to the C6-C16 or C8-C16 fraction of a C4+ biofuel, in particular a C4-C20 or C6-C20 biofuel, the biofuel being produced by a method for converting into fuel at least one C2 bioalcohol.

In one embodiment, the at least one aromatic base b) can be a C8-C16 aromatic base and said aromatic base corresponds to the C8-C16 fraction of a C6-C20 biofuel produced by a method for converting into fuel at least one C2 bioalcohol.

It should be noted that a proportion of paraffinic base of 65% to 95% by mass, and respectively of 70% to 95% by mass, corresponds to a proportion of approximately 68% to 96% by volume, and respectively approximately 73% to 96% by volume. A proportion of aromatic base of 5% to 35% by mass, and respectively of 5% to 30% by mass, corresponds to a proportion of approximately 4% to 32% by volume, and respectively approximately 4% to 27% by volume.

Advantageously, the jet-fuel composition comprises from 70% to 80% by mass of at least one paraffinic base a), preferably from 80% to 85%, preferentially from 85% to 92% by mass, even more preferentially from 92% to 95% by mass.

Advantageously, the jet-fuel composition comprises from 20% to 30% by mass of the at least one aromatic base b), preferably from 15% to 20% by mass, preferentially from 8% to 15% by mass, even more preferentially from 5 to 8% by mass.

Advantageously, the at least one aromatic base according to b) contains at least 70% by mass of aromatic compounds, preferably at least 80% by mass of aromatic compounds, preferentially at least 90% by mass of aromatic compounds. In particular, these aromatic compounds are mainly (namely to the extent of more than 50% by mass) monoaromatic compounds.

Advantageously, the at least one paraffinic base a) is produced from one or more oils selected from vegetable oils, animal fats, preferentially inedible highly saturated oils, waste oils, byproducts of the refining of vegetable oils or animal oil or oils containing free fatty acids, tallols, and oils produced by bacteria, yeasts, algae, prokaryotes or eukaryotes.

The invention also relates to a method for producing a jet-fuel composition coming from renewable feedstocks comprising at least the following steps:
a) The production of at least one paraffinic base from a hydrotreatment of esters and fatty acids or a Fisher-Tropsch method, said at least one paraffinic base comprising at least 90% by mass of paraffins
b) The production of at least one C6-C16 or C8-C16 aromatic base comprising at least the following steps:
   i) the production of a biofuel by a method for converting into fuel bioethanol alone or in a mixture with other C1-C6 bioalcohols,
   ii) the recovery of said C6-C16 or C8-C16 aromatic base by fractionation of said biofuel obtained at step i)
said C6-C16 or C8-C16 aromatic base comprising at least 60% of aromatic compounds, said aromatic compounds comprising at least 50% by mass of benzene substituted by at least n C2-C5 alkyl, n being an integer from 1 to 3,
c) The mixture of 65% to 95% by mass, preferably from 70% to 95% by mass, of the at least one paraffinic base produced at step a) with 5% to 35% by mass, preferably with 5% to 30% by mass, of the at least one aromatic base produced at step b) to obtain a jet-fuel composition containing less than 9.5% by mass of C6-C16 cycloalkanes.

In one embodiment, step b) i) is a step of producing a C4+ biofuel, in particular in C4-C20 or in C6-C20, by a method for converting into fuel bioethanol alone or in a mixture with other C1-C6 bioalcohols.

Advantageously, the at least one paraffinic base coming from step a) is produced from one or more oils selected from vegetable oils, animal fats, preferentially inedible highly saturated oils, waste oils, byproducts of the refining of vegetable oils or of animal oil or oils containing free fatty acids, tallols, and oils produced by bacteria, yeasts, algae, prokaryotes or eukaryotes.

Advantageously, step c) comprises mixing from 70% to 80% by mass of the at least one paraffinic base produced at step a) with 20% to 30% by mass of the at least one aromatic base produced at step b).

Alternatively, step c) comprises mixing 80% to 85% by mass of the at least one paraffinic base produced at step a) with 20% to 15% by mass of the at least one aromatic base produced at step b).

Alternatively, step c) comprises mixing from 85% to 92% by mass of the at least one paraffinic base produced at step a) with 15% to 8% by mass of the at least one aromatic base produced at step b).

Alternatively, step c) comprises mixing from 92% to 95% by mass of the at least one paraffinic base produced at step a) with 5% to 8% by mass of the at least one aromatic base produced at step b).

Steps a), b) and c) can be implemented in distinct methods.

### DETAILED DESCRIPTION OF THE INVENTION

The terms “comprising” and “comprises” as used here are synonymous with “including”, “includes” or “contains”, “containing”, and are inclusive and without bounds and do not exclude unspecified additional characteristics, elements or method steps.

The expressions % by weight and % by mass have an equivalent meaning and refer to the proportion of the mass of a product with respect to 100 g of a composition comprising same.

The distributions of the number of carbon atoms are determined by the distribution of the actual boiling point and by gas chromatography. As used in this specification, the total quantity of paraffins and isoparaffins at a given number of carbon atoms is determined by the standard NF EN ISO 22854 for aromatic cuts and by gas chromatography (GCxGC) for mixtures of paraffinic base and aromatic cut.

The proportion of aromatic compounds and naphthenes can be determined by reversed-phase gas chromatography (GcxGC reversed-phase). The proportion of aromatic compounds can be determined in accordance with ASTM D1319-20A.

The boiling points as mentioned here are measured at atmospheric pressure unless indicated otherwise. An initial boiling point is defined as the temperature value as from which a first vapour bubble is formed. A final boiling point is the highest temperature that can be reached during distillation. At this temperature no further vapour can be transported to a condenser. Determining the initial and final boiling points has recourse to techniques known in the art and several methods adapted according to the distillation temperature range are applicable. Recourse can be had here to standard ASTM D86-20b.

The freezing point of a hydrocarbon of the jet-fuel type can be measured in accordance with standards ASTM D2386-19/D7153-15e1/D5972-16/IP 435 (2016).

The density of a hydrocarbon of the jet-fuel type can be measured in accordance with standard ASTM D4052-18 or IP 365.

### Paraffinic Base According to the Invention

Paraffinic base means a paraffinic synthetic fuel produced from raw material of nonpetroleum origin compatible with ASTM D7566:21 specification and containing at least 90% by mass, and more often at least 95% by mass of paraffinic compounds.

These paraffinic compounds typically comprise isoparaffins, n-paraffins and cyclo-paraffins, the isoparaffins advantageously be present in a majority (at more than 50% by mass).

Said paraffinic synthetic fuel is advantageously a synthetic paraffinic kerosene (SPK) coming from a hydrotreatment of esters and fatty acids (SPK-HEFA) or coming from a Fisher-Tropsch method (SPK-FT).

The paraffinic synthetic fuel of the present invention is thus a renewable fuel obtained solely from compounds of non-fossil origin.

The renewable paraffinic synthetic fuel SPK-HEFA can be produced from oil(s) of natural origin by a method of hydrogenation and deoxygenation of fatty acid esters and free fatty acids and from the subsequent treatment of the product comprising hydrocracking, or hydroisomerisation, or isomerisation, or a combination of these steps, and can include other conventional refining methods. In other words, the renewable paraffinic synthetic fuel SPK-HEFA is produced using hydrotreatment of esters and fatty acids of an oil of natural origin.

An oil of natural origin is defined as an oil of biomass origin not containing any mineral oil. In the description, “oil(s) of natural origin” designates indifferently oils, fats and mixtures thereof.

Said oil or oils of natural origin can contain one or more oils selected from vegetable oils, animal fats, preferentially inedible highly saturated oils, waste oils, byproducts of the refining of vegetable oil(s) or of animal oil(s) containing free fatty acids, tallols and oils produced by bacteria, yeasts, algae, prokaryotes and eukaryotes.

Suitable vegetable oils are for example palm oil, palm kernel oil, soya oil, colza (colza or canola) oil, sunflower oil, flaxseed oil, bran oil, rice oil, maize oil, olive oil, castor oil, sesame oil, pine oil, groundnut oil, mustard oil, carinata oil, hemp oil, coconut oil, babassu oil, cotton seed oil, linola oil, Jatropha oil.

Animal fats comprise suet, lard, grease (yellow and brown grease), fish oil/fat, fat, milk fats.

Refining byproducts of vegetable or animal oils are byproducts containing free fatty acids that are eliminated from the raw fats and oils by neutralisation or distillation under vacuum or steam. A typical example is PFAD (Palm Fatty Acid Distillate).

Waste oils comprise waste cooking oils (waste food oils) and oils recovered from wastewater, such as drained fats/oils, gutter oils, sewer oils, for example from water purification stations, and waste greases from the food industry.

Tall oils, including raw tall oils, distillated tall oils (DTO) and tall oil fatty acids (TOFA), preferably DTO and TOFA, can also be used in the present invention.

Tall oil, or otherwise referred to as tallol, is a liquid byproduct of the Kraft wood transformation method, making it possible to isolate firstly the wood pulp useful to the papermaking industry. Tall oil is mainly obtained when conifers are used in the Kraft method. After treatment of the wood chips with sodium sulphide in aqueous solution, the tall oil isolated is alkaline. The latter is next acidified with sulphuric acid to produce raw tall oil.

The oil or oils of natural origin used in the present invention also comprise oils produced by microorganisms, either natural microorganisms or genetically modified microorganisms such as bacteria, yeasts, algae, prokaryotes or eukaryotes. In particular, such oils can be recovered by well-known mechanical or chemical extraction methods.

The renewable paraffinic synthetic fuel SPK-FT comes from a Fisher-Tropsch method and can be produced from solid biomass. Thermochemical conversion of the biomass (gasification and Fischer-Tropsch synthesis), also referred to as BtL (Biomass to Liquid), comprises the following steps: conditioning the biomass (preparation, triturating, torrefaction), gasification of the biomass (obtaining a synthesis gas), purification of the synthesis gas, Fisher-Tropsch synthesis to transform the gas into synthesis biofuel.

Whatever the aforementioned method used, the paraffinic synthetic fuel can have been subjected to a distillation step before it is incorporated in the composition of the invention, in order to eliminate the heaviest paraffins which would not make it possible to comply with the cold properties of the jet fuel in particular the point at which crystals disappear which must be below −47° C. for jet fuel A1. The lightest compounds can also be separated by distillation, in order to comply, in particular, with the volatility properties and the flashpoint of Jet A1.

Whatever the aforementioned method used, the renewable paraffinic synthetic fuel can have one or more of the following characteristics:
a paraffin content of more than 90% by mass,
a cycloparaffin content of less than 10% by mass,
a freezing point below −30° C., preferably below −40° C., for example below −47° C.,
a density at 15° C. of between 730 and 780 kg/m³,
a distillation range of 145° C. to 315° C.,
an isoparaffin content of 70% by mass or more.

### Aromatic Base According to the Invention

The C6-C16 or C8-C16 aromatic base can be produced in accordance with the following steps:
i) producing a biofuel by subjecting bioethanol coming from at least one renewable feedstock to a method for converting alcohol into fuel,
ii) recovering said C6-C16 or C8-C16 aromatic base coming from said biofuel obtained at step i).

In one embodiment, the aromatic base is a C8-C16 aromatic base.

The biofuel produced at step i) is typically a C4+ biofuel, in particular in C4-C20 or in C6-C20.

The C6-C16 or C8-C16 aromatic base can be produced in accordance with the following steps:
i) producing a C4+, in particular in C4-C20 or in C6-C20, biofuel by subjecting bioethanol coming from at least one renewable feedstock to a method for converting alcohol into fuel,
ii) recovering said C6-C16 or C8-C16 aromatic base coming from said biofuel obtained at step i).

### Step i): Production of a Biofuel

The production of the biofuel according to step i) can be obtained by converting bioethanol alone or in a mixture with other C1-C6 bioalcohols, in a catalytic method. The catalytic method can be implemented on an aluminosilicate bed, preferably of the zeolite type.

Bioethanol can be produced using the ethanolic fermentation by fermentary action of microorganisms, yeasts and/or bacteria of at least one raw material of vegetable origin.

One method for obtaining biofuel, in particular a C4+ biofuel, for example in C4-C20 or in C6-C20, is described for example in the patents EP2940103 or EP3307853.

### Step ii): Recovery of the C6-C16 or C8-C16 Aromatic Base

The biofuel obtained in step i), in particular the C4+ biofuel, for example in C4-C20 or in C6-C20, is fractionated to recover the C6-C16 or C8-C16 faction in order to satisfy the volatility properties of aviation fuels.

The C6-C16 or C8-C16 aromatic base according to the invention can have one or more of the following characteristics:
at least 60% by mass o C8-C16 aromatic compounds, in particular monoaromatic compounds, said aromatic compounds comprising at least 50% by mass o benzene substituted by at least n C2-C5 alkyl, n being an integer from 1 to 3,
from 8% by mass to 15% by mass of naphthenes,
from 5% by mass to 15% by mass of isoparaffins,
less than 5% by mass of n-paraffins,
a density of 855 to 870 kg/m³ measured in accordance with standard ASTM D1298-12b (2017).

It should be noted that said aromatic compounds present in a proportion of at least 60% by mass comprise benzene substituted by at least n C2-C5 alkyl. These aromatic compounds can thus comprise a mixture of benzene molecules substituted by at least n C2-C5 alkyl and optionally benzene molecules substituted by at least n C2-C5 alkyl and by m methyl, m being an integer from 1 to 3.

In particular, the production of the paraffinic and aromatic bases according to the invention can be implemented using different renewable sources, and in particular by separate methods.

### Mixture According to the Invention

Advantageously, the jet-fuel composition according to the invention can be in accordance with the Jet A or JET A1 requirements as defined in standard ASTM D7566:2021 of July 2021 corresponding substantially to DefStan 91-091 Issue 12, or in DefStan 91-091 Issue 11, which refers to standard ASTM D7566:21. In particular, the proportions of paraffinic base a) and aromatic base b) in the jet-fuel composition according to the invention can be selected so that the jet-fuel composition according to the invention is in accordance with these requirements.

In an advantageous embodiment, the at least one paraffinic base a) and the at least one aromatic base b) come from separate treatments of renewable feedstocks (from distinct methods), in particular of distinct renewable feedstocks.

In a preferred embodiment, the jet-fuel composition according to the invention consists of paraffinic a) and aromatic b) bases coming from renewable feedstocks. In particular, the jet-fuel composition according to the invention is free from components of petroleum origin.

### DESCRIPTION OF FIGURES

FIG. 1: Distribution of the hydrocarbons in the mixture according to example 1.

FIG. 2: curve of change in the smoke point as a function of the aromatic content of cuts 150-230° C.

The following examples illustrate the invention without limiting the scope thereof.

### EXAMPLES

### Example 1

A mixture according to the invention is prepared. The mixture contains 90% by mass of HEFA conforming to the paraffinic base a) according to the invention and 10% by mass of the C8-C16 aromatic base b).

Other additives can be added to the composition so that the jet-fuel composition according to the invention is in accordance with the requirements of standard ASTM D7566:21.

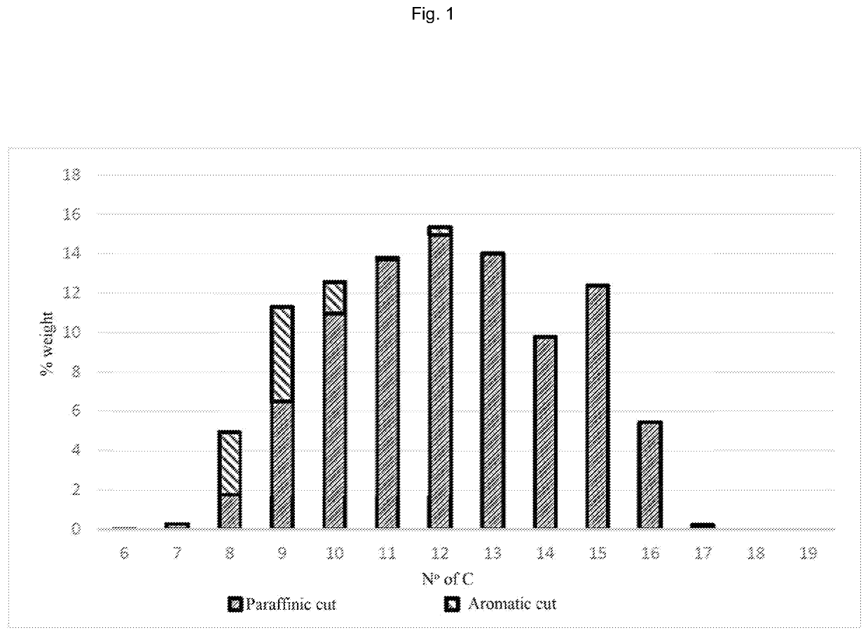

Adding the aromatic base b) makes it possible to obtain a composition wherein the C8-C12 content is increased, as shown on FIG. 1.

Compared with a fossil jet fuel, the composition according to the invention has a small polycyclic aromatic hydrocarbon content. Thus, the quantity of monoaromatics hydrocarbons with respect to the total quantity of aromatic hydrocarbons is higher for the present composition than for fossil jet fuel. The composition is thus useful for reducing the polyaromatic hydrocarbon content of a fuel and increasing the proportion of monoaromatic hydrocarbons. Advantages are obtained in terms of improving the combustion with an improvement in the smoke point and a reduction in soot emissions.

### Example 2—Effect on the Smoke Point

Kerosene cuts (150-230° C.) coming from various crudes of fossil origin were analysed in order to determine their aromatic compound content and the smoke point.

The smoke point was determined in accordance with standard ASTM D1322-19.

The aromatic compound content was determined in accordance with standard ASTM D1319-20A.

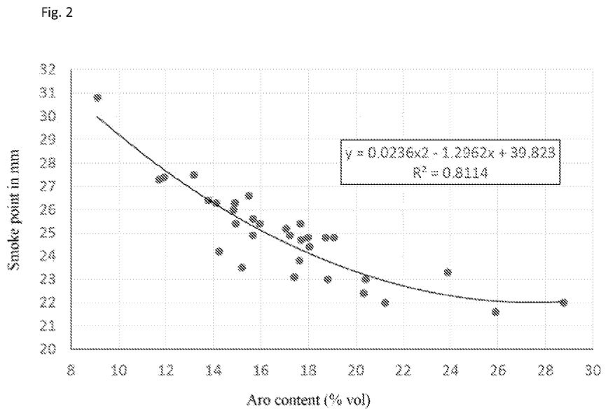

FIG. 2 shows the change in the smoke point as a function of the aromatics content of these kerosene cuts.

C1-C4 jet-fuel compositions according to the invention were prepared in the proportions set out in table 1. These compositions are mixtures of an SBK-HEFA (density of 760.9 kg/m³) with an aromatic base A1 (C1 composition) or with an aromatic base A2 (C2-C4 compositions).

The aromatic base A1 corresponds to a 140+° C. cut of a biofuel. The aromatic base A2 corresponds to a 135+° C. cut of a biofuel. These bases contain mainly compounds with a cut point of 150° C. and more.

The characteristics of the aromatic bases A1 and A2 are set out in tables 2 to 4. The density was determined in accordance with standard ASTM D1298-12b (2017).

The smoke point of the C1-C4 compositions was measured and is set out in table 1.

TABLE 1

| | C1 | C2 | C3 | C4 | SPK-HEFA |
|---|---|---|---|---|---|
| SPK-HEFA vol % | 86.00 | 85.00 | 90.00 | 95.60 | 100.0 |
| aromatic base vol % | 14.00 | 15.00 | 10.00 | 4.40 | 0.00 |
| % mass SPK-HEFA mass % | 84.34 | 83.34 | 88.82 | 95.00 | 100.00 |
| aromatic base mass % | 15.66 | 16.66 | 11.18 | 5.00 | 0.00 |
| Smoke point (mm) | 32.1 | 33.0 | 43.0 | 42.0 | 51.3 |

TABLE 2

| | Aromatic base A1 | | | | Aromatic base A2 | | | |
|---|---|---|---|---|---|---|---|---|
| | Density | | | | | | | |
| | 868 kg/m³ | | | | 862 kg/m³ | | | |
| | Composition | | | | | | | |
| | | | (% m) | (% vol) | | | (% m) | (% vol) |
| cuts | 140-145° | C. | 5.05 | 5.18 | 135-150° | C. | 21.87 | 22.50 |
| | 145-150° | C. | 3.03 | 3.10 | 150+° | C. | 78.13 | 77.50 |
| | 150+° | C. | 91.92 | 91.72 | | | | |

TABLE 3
Composition of base A1 by analysis in accordance
with standard NF EN ISO 22854
Aromatic base A1

| (% m) | C1-C7 | C8 | C9 | C10 | C11 | C12+ | Total |
|---|---|---|---|---|---|---|---|
| Naphthenes | 0.00 | 0.06 | 1.89 | 1.48 | 0.21 | 0.00 | 3.65 |
| Isoparaffins | 0.00 | 0.00 | 0.60 | 0.87 | 0.37 | 0.00 | 1.85 |
| N-paraffins | 0.00 | 0.00 | 0.07 | 0.02 | 0.00 | 0.00 | 0.09 |
| Cyclo-olefins | 0.00 | 0.02 | 0.40 | 0.44 | 0.12 | 0.00 | 0.98 |
| Olefins | 0.00 | 0.00 | 0.01 | 0.00 | 0.00 | 0.00 | 0.01 |
| Aromatics | 0.00 | 9.51 | 78.10 | | 0.00 | 0.00 | 0.00 |
| Compounds with | | | | | | | 5.05 ⁽¹⁾ |
| a cut point of | | | | | | | |
| 200+° C. | | | | | | | |
| Polynaphthenes | | | | | | | 0.76 |
| Total | | | | | | | 100.00 |

⁽¹⁾ including 4.25% m of C11+

TABLE 4
Composition of base A2 by analysis in accordance
with standard NF EN ISO 22854
Aromatic base A2

| (% m) | C1-C6 | C7 | C8 | C9 | C10 | C11 | C12+ | Total |
|---|---|---|---|---|---|---|---|---|
| Naphthenes | 0.00 | 0.00 | 0.63 | 3.09 | 1.51 | 0.27 | 0.00 | 5.50 |
| Isoparaffins | 0.00 | 0.00 | 0.12 | 2.03 | 0.94 | 0.37 | 0.00 | 3.46 |
| N-paraffins | 0.00 | 0.00 | 0.03 | 0.09 | 0.02 | 0.00 | 0.00 | 0.14 |
| Cyclo-olefins | 0.00 | 0.00 | 0.15 | 0.56 | 0.33 | 0.08 | 0.00 | 1.11 |
| Olefins | 0.00 | 0.00 | 0.00 | 0.04 | 0.00 | 0.03 | 0.00 | 0.07 |
| Aromatics | 0.00 | 0.05 | 17.80 | 67.26 | | 0.00 | 0.00 | 85.11 |
| Compounds with | | | | | | | | 3.96 ⁽¹⁾ |
| a cut point of | | | | | | | | |
| 200+° C. | | | | | | | | |
| Polynaphthenes | | | | | | | | 0.65 |
| Total | | | | | | | | 100.00 |

⁽¹⁾ including 3.47% m of C11+

Table 5 sets out the total aromatics contents of compositions C1 and C2.

TABLE 5

| | Aromatic content | Aromatic content |
|---|---|---|
| | (% m) by | (% vol) by |
| Composition | NF EN ISO 22854 | FIA - ASTM D1319) |
| C1 | 14.4 | 13.3 |
| C2 | 14.84 | 12.4 |

As can be seen on FIG. 2, a jet fuel of fossil origin having a total proportion of aromatic compounds of 12 or 13% by volume has a smoke point of 27-28 mm whereas the jet fuels according to the invention have a smoke point of 32-33 mm. This difference from the values of fossil jet fuels is greater than the reproducibility of the standard and shows the improvement in the smoke point of the fuel compositions according to the invention.

Moreover, as shown by table 1, an effect on the smoke point compared with the fossil jet fuels is observed as from 4.4% by volume of aromatic base.

### Example 3—Effect on the Density and Viscosity

The kinematic viscosities at −20° C. and −40° C. were determined in accordance with ASTM D445-21 for the C2-C4 mixtures of example 2.

The values of the kinematic viscosities are presented in table 6 and compared with the values calculated according to the mixing law. In the table, R represents the reproducibility of the measurement at −20° C. (the same reproducibility was used for the viscosities at −20 and −40 C since the standard does not give a reproducibility for viscosity at −40° C.).

TABLE 6

| Composition | C2 | C3 | C4 |
|---|---|---|---|
| SPK-HEFA content (% vol) | 85.0 | 90.0 | 95.60 |
| Kinematic viscosity at −20° C. − R | 4.543 | 4.841 | 5.424 |
| Kinematic viscosity at −20° C. measured | 4.568 | 4.868 | 5.455 |
| Kinematic viscosity at −20° C. + R | 4.593 | 4.895 | 5.486 |
| Kinematic viscosity at −20° C. Calculated | 4.624 | 4.970 | 5.467 |
| Kinematic viscosity at −40° C. − R | 9.337 | 10.349 | 12.013 |
| Kinematic viscosity at −40° C. measured | 9.408 | 10.43 | 12.11 |
| Kinematic viscosity at −40° C. + R | 9.479 | 10.511 | 12.207 |
| Kinematic viscosity at −40° C. Calculated | 9.818 | 10.81 | 12.28 |

Despite the high density of the aromatic base A2, a reduction in the kinematic viscosity is observed at −20° C. and −40° C. of the jet-fuel compositions according to the invention produced with this aromatic base, provided that the composition contains more than 4% by volume of aromatic base.

1. Jet-fuel composition coming from renewable feedstocks comprising:
a. from 65% to 95% by mass, preferably from 70% to 95% by mass, of at least one paraffinic base coming from a hydrotreatment of esters and fatty acids or from a Fischer-Tropsch method and comprising at least 90% by mass of paraffins,
b. from 5% to 35% by mass, preferably from 5% to 30% by mass, of at least one C6-C16 or C8-C16 aromatic base, characterised in that said aromatic base corresponds to the C6-C16 or C8-C16 fraction of a biofuel produced by a method for converting into fuel at least one C2 bioalcohol and characterised in that said aromatic base contains at least 60% by mass of aromatic compounds, said aromatic compounds comprising at least 50% by mass benzene substituted by at least n C2-C5 alkyl, n being an integer from 1 to 3,
wherein said jet-fuel composition comprises less than 9.5% by mass C6-C16 cycloalkanes.

2. Jet-fuel composition according to claim 1, wherein the at least one aromatic base corresponds to the C6-C16 or C8-C16 fraction of a C4+ biofuel, in particular a C4-C20 or C6-C20 biofuel, produced by a method for converting into fuel at least one C2 bioalcohol.

3. Jet-fuel composition according to claim 1, comprising from 70% to 80% by mass the at least one paraffinic base a), preferably from 80% to 85% by mass the at least one paraffinic base a), preferentially from 85% to 92% by mass the at least one paraffinic base a), even more preferentially from 92% to 95% by mass.

4. Jet-fuel composition according to claim 1, comprising from 20% to 30% by mass the at least one aromatic base b), preferably from 15% to 20% by mass the at least one aromatic base, preferentially from 8% to 15% by mass the at least one aromatic base b), even more preferentially from 5% to 8% by mass.

5. Jet-fuel composition according to claim 1, characterised in that the aromatic base according to b) contains at least 70% by mass aromatic compounds, preferably at least 80% by mass aromatic compounds, preferentially at least 90% by mass aromatic compounds.

6. Jet-fuel composition according to claim 1, characterised in that, the at least one paraffinic base a) is produced from one or more oils selected from vegetable oils, animal fats, preferentially inedible highly saturated oils, waste oils, byproducts of the refining of vegetable oils or animal oil or oils containing free fatty acids, tallols, and oils produced by bacteria, yeasts, algae, prokaryotes or eukaryotes.

7. Method for producing a jet-fuel composition coming from renewable feedstocks comprising at least the following steps:
a) The production of at least one paraffinic base from a hydrotreatment of esters and fatty acids or a Fisher-Tropsch method, said at least one paraffinic base comprising at least 90% by mass paraffins
b) The production of at least one C6-C16 or C8-C16 aromatic base comprising at least the following steps:
i) the production of a biofuel by a method for converting into fuel bioethanol alone or in a mixture with other C1-C6 bioalcohols,
ii) the recovery of said C6-C16 or C8-C16 aromatic base by fractionation of said biofuel obtained at step i), said C6-C16 or C8-C16 aromatic base comprising at least 60% by mass aromatic compounds, said aromatic compounds comprising at least 50% by mass of benzene substituted by at least n C2-C5 alkyl, n being an integer from 1 to 3,
c) The mixture of 65% to 95% by mass, preferably from 70% to 95% by mass, of the at least one paraffinic base produced at step a) with 5% to 35% by mass, preferably with 5% to 30% by mass, of the at least one aromatic base produced at step b) to obtain a jet-fuel composition containing less than 9.5% by mass of C6-C16 cycloalkanes.

8. Method for producing a jet-fuel composition coming from renewable feedstocks according to claim 7, characterised in that step b) i) is a step of producing a C4+ biofuel, in particular in C4-C20 or in C6-C20.

9. Method for producing a jet-fuel composition coming from renewable feedstocks according to claim 7, characterised in that the at least one paraffinic base a) is produced from one or more oils selected from vegetable oils, animal fats, preferentially inedible highly saturated oils, waste oils, byproducts of the refining of vegetable oils or animal oil or oils containing free fatty acids, tallols, and oils produced by bacteria, yeasts, algae, prokaryotes or eukaryotes.

10. Method for producing a jet-fuel composition coming from renewable feedstocks according to claim 7, characterised in that the mixing of step c) comprises the mixing of 70% to 80% by mass of the at least one paraffinic base produced at step a) with 20% to 30% by mass of the at least one aromatic base produced at step b), preferably step c) comprises the mixing of 80% to 85% by mass of the at least one paraffinic base produced at step a) with 20% to 15% by mass of the at least one aromatic base produced at step b), preferentially step c) comprises the mixing of 85% to 92% by mass of the at least one paraffinic base produced at step a) with 15% to 8% by mass of the at least one aromatic base produced at step b), even more preferentially step c) comprises the mixing of 92% to 95% by mass of the at least one paraffinic base produced at step a) with 5% to 8% by mass of the at least one aromatic base produced at step b).

11. Method for producing a jet-fuel composition according to claim 7, characterised in that steps a), b) and c) are implemented in distinct methods.
